(19) United States
(12) Patent Application Publication
(10) Pub. No.: US 2019/0021277 A1
(43) Pub. Date: Jan. 24, 2019

(54) ANIMAL BED WITH REMOVABLE THERAPY DEVICE

(71) Applicant: Daniel H. Godfrey, Portland, OR (US)

(72) Inventor: Daniel H. Godfrey, Portland, OR (US)

(21) Appl. No.: 15/956,735

(22) Filed: Apr. 18, 2018

Related U.S. Application Data
(60) Provisional application No. 62/486,968, filed on Apr. 18, 2017.

(51) Int. Cl. A01K 1/035

(52) U.S. Cl. CPC A01K 1/0353; A01K 1/0158

(57) ABSTRACT

An animal bed for receiving a therapy device therein. It has a first surface for allowing the animal to rest thereon, an opposite therapy surface for allowing the animal to be treated with a therapy device while resting thereon, and a chamber for detachably receiving the therapy device therein. In disclosed embodiments the therapy device is a magnetic therapy device, a temperature therapy device, a vibration therapy device, a Transcutaneous Electrical Nerve Stimulation (“TENS”) device, a Pulsed Electromagnetic Field Therapy (“PEMF”) device or a combination of one or more of these devices. The bed can include reinforced corners that may have surface ornamentation different from that of the main bed surface.

### CROSS REFERENCE To RELATED APPLICATION

This application claims priority to U.S. provisional patent application Ser. No. 62/486,968 filed on Apr. 18, 2017, the disclosure of which is hereby incorporated by reference.

### FIELD OF THE INVENTION

The present invention relates to an animal bed with a therapy device detachably secured therein.

### BACKGROUND & SUMMARY

Animal beds provide padded comfort for animals such as dogs when resting. However, there has been limited success with providing a durable animal bed that can also be used to administer a therapeutic treatment as the animal rests on the bed.

For example, U.S. Pat. No. 7,117,816 discloses placing a complete heating element within a bed structure. The element is not easily removed and replaced, and it does not allow for other forms of pet therapy to be used in place of the heating element.

Accordingly, there remains a need for a pet therapy bed that allows a pet to rest on it comfortably when not using it for therapy, but also allows a pet therapy device to be detachably secured thereto as needed. These and other objects of the inventions are set forth in more detail in the following description and claims.

### FIGURE DESCRIPTIONS

The foregoing Summary and the following Detailed Description will be better understood when read in conjunction with the accompanying figures.

FIG. 1 is a top, front isometric view of an animal bed in accordance with an embodiment of the invention.

FIG. 2 is a bottom, front isometric view of the animal bed of FIG. 1 showing possible insertion of a therapy device therein (here two therapy devices are, shown).

FIG. 3 is a top, plan view of the animal bed of FIG. 1.

FIG. 4 is a back, plan view of the animal bed of FIG. 1.

FIG. 5 is a front, plan view of the animal bed of FIG. 1.

FIG. 6 is a right side, plan view of the animal bed of FIG. 1.

FIG. 7 is a left side, plan view of the animal bed of FIG. 1.

FIG. 8 is a bottom, plan view of the animal bed of FIG. 1.

FIG. 9 is an enlarged cross-sectional view of the animal bed of FIG. 1 taken along line 9-9 of FIG. 8.

FIG. 10 is an enlarged cross-sectional view of the animal bed of FIG. 1 taken along line 10-10 of FIG. 8.

FIG. 11 is an enlarged cross-sectional view of the animal bed of FIG. 1 taken along line 11-11 of FIG. 8

### DETAILED DESCRIPTION

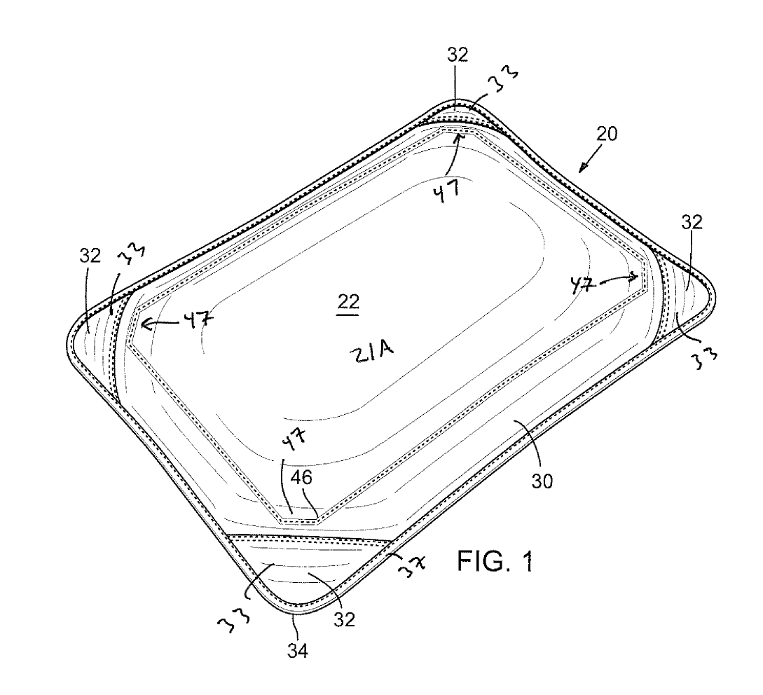

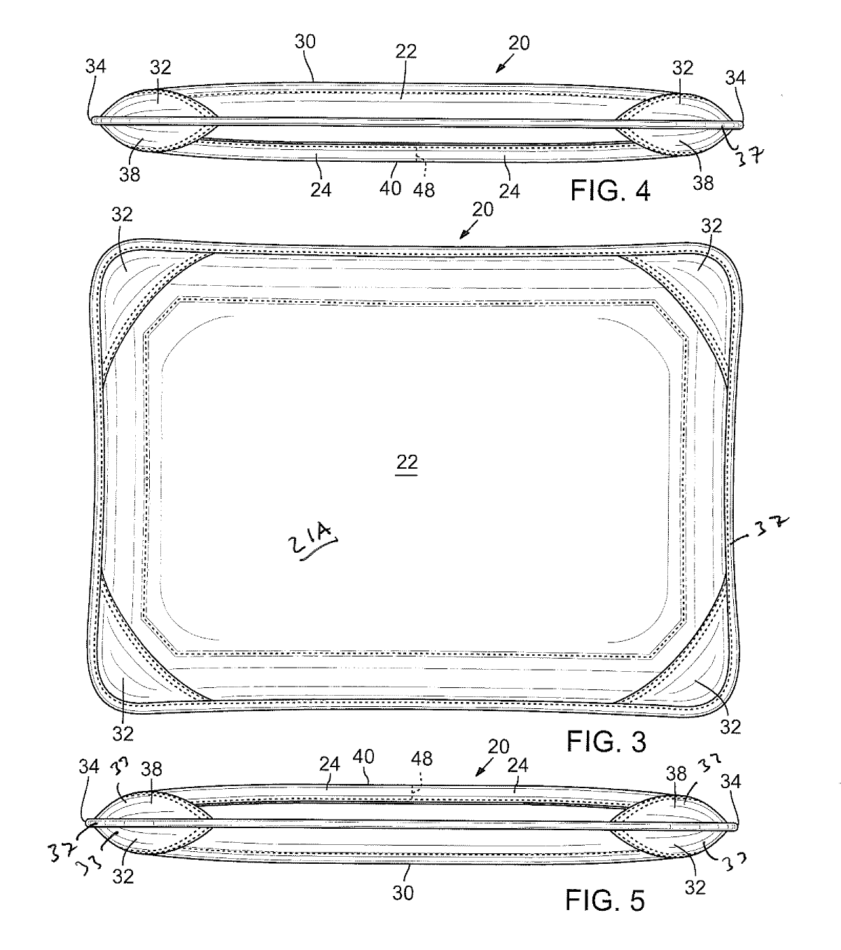

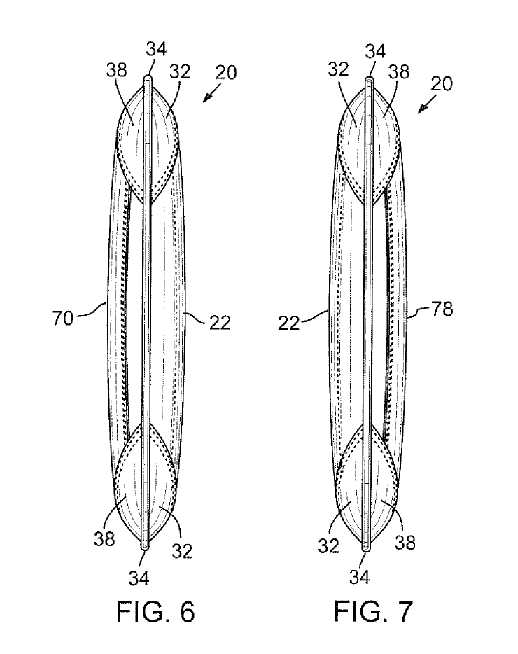

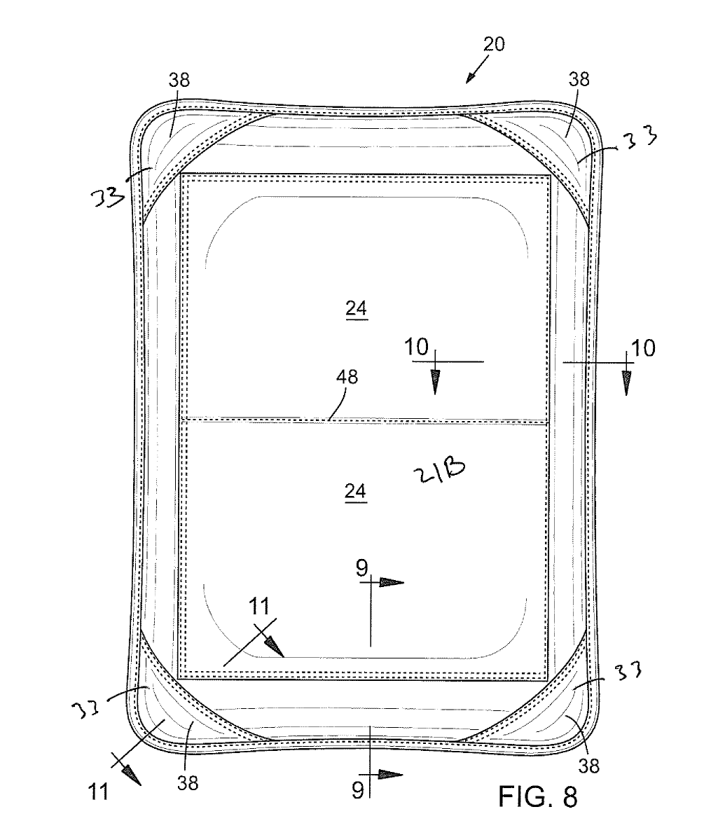

An animal bed 20 with one or more removable therapy device(s) 26 detachably secured thereto is shown in FIGS. 1-11. The bed 20 preferably has a padded side 22A and an opposite therapy side 228. The padded side 22A preferably includes a padded section 24 that the animal, such as a dog or the like, may rest upon. The therapy side 21B preferably includes are one or more pockets 24 (two shown) for detachably receiving the therapy device 26, such as a temperature therapy device, therein. Accordingly, the bed 20 may serve as either a padded bed by positioning the padded side 21A up, or as a therapy device by positioning the therapy side 21B up. Each of these elements is discussed in greater detail below.

General Bed Construction

As best shown in FIGS. 1, 2, and 9-11, the bed 20 is preferably constructed with a durable, flexible sheet or sheets of material forming a substantially planar upper surface 30 and a substantially planar lower surface 36 to define a chamber there between for receiving padding 22 therein. The circumferential edge 34 of the bed includes a joining structure, such as a band of material 37 covering the edges of the sheets of materials and stitching of the like for joining the upper and lower surfaces together at the edge.

The padding 22 is preferably formed of two sheets, an upper sheet 22A, and a lower sheet 22B. The upper sheet is secured in place to the sheet of material forming the upper surface with stitching 46. Preferably, and as best shown in FIG. 1, this stitching is spaced inward from the outer edge of the bed and includes angled corners 47 that do not interfere with corner material 33 operably secured at each corner of the bed. The lower sheet is secured during manufacturing to the sheet of material forming the lower surface 36 though stitching along the outer edge or the like.

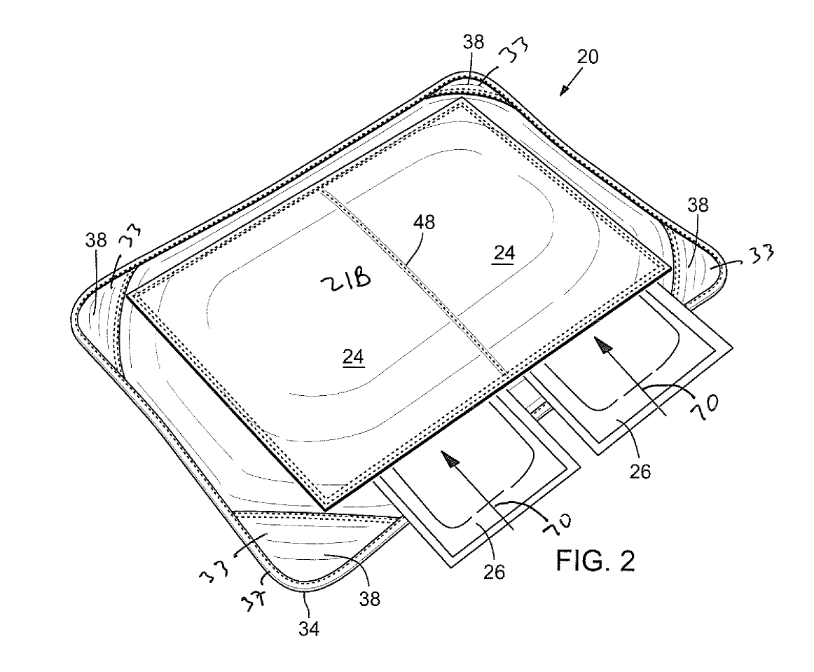

Preferably, the durable corner material 33 is provided at the upper corners 32 and lower corners 34 of bed 20 as best shown in FIGS. 1 and 2, to further reinforce the corners. More preferably, the durable corner material includes a color and/or surface ornamentation different from that of the material forming the upper surface 22 and/or lower surface 36 of the bed. The visually different corners can be used to alert a consumer of unique properties of the bed. For example, they can allow the bed to be easily identified as having the ability to allow therapy devices to be detachably secured thereto. They can also be used to indicate the source or origin of the particular manufacturer of the bed for quality assurance purposes.

As best shown in FIG. 11, a second layer 37 of more durable material is also provided in the corners under the durable corner material. The durable corner material and second layer of more durable material is operably secured the upper and lower surfaces as shown such as by sticking or the like.

More preferably, and as best shown in FIG. 1, a line of stitching 45 spaced inward from the outer edge 34 of the bed 22 is provided. This stitching operably secures the padding within the bed to prevent it from shifting. It also can be used to allow the bed to be easily identified as having the ability to allow therapy devices to be detachably secured thereto. They can also be used to indicate the source or origin of the particular manufacturer of the bed for quality assurance purposes.

Pocket

Referring now to FIGS. 2, 8, 9 & 10, the bed 20 preferably incudes one or more pockets 24 for detachably receiving a therapy device 26 therein. Preferably, the pocket 24 is operably secured to the lower surface of the bed as shown such as by stitching three of the four edges of the pocket to the lower surface to define a pocket opening for receiving therapy devices there through. FIG. 2 shows two therapy devices 26 being inserted in the direction of the arrows 70 into pocket openings of pockets 24.

Preferably the edge of the pocket openings includes a securing structure for allowing detachable opening and closing of the pocket opening. Hook and loop material secured along the edge of the pocket opening has been found to work particularly well for this purpose. It allows the closed pocket edge to remain secure while limiting an animal's ability to grasp the enclosing structure and possibly chew or otherwise damage it.

Alternatively, only one edge of the pocket may be rigidly secured to the bed with stitching or the like. The other three edges could then include securing structures, such as strips of hook and loop material along each respective edge. This orientation would allow the pocket to be opened like a flap to allow therapy devices to be operably secured to the bed. Then the flap could be closed to engage the strips of hook and loop material thereby closing the therapy device therein.

Preferably, each pet bed is constructed using a tough 1000 denier Cordura Nylon outer fabric. The inside is made using a 10 once fiberfill batting and each of the rounded corners and pockets of the bed is protected utilizing a 40 ounce truck tarp material creating the ultimate chew and scratch resistant pet bed. The materials are preferably water resistant.

Therapy Devices

As best shown in FIGS. 2, 9, 10 & 11, the therapy device 26 may be a temperature therapy device such as a substantially planar hot/cold pack. Such hot/cold packs are known and an exemplar pack is described in U.S. Pat. No. 5,843,145 to Brink, the disclosure of which is hereby incorporated by reference.

The temperature therapy device can provide both cooling relief to an over-heated animal such as a pet, or soothing warmth to a chilled, or arthritic pet. The time-tested gel packs can be cooled in the freezer or warmed in the microwave. Simply slide the gel packs into the reinforced chew resistant and scratch resistant pockets to provide your pet the desired temperature relief they require. If no therapy is required, leave the gel packs in place, and turn the bed over to provide your pet a relaxing multi-layered pillow top comfort. If desired, the cooling effect can also be felt through the padding

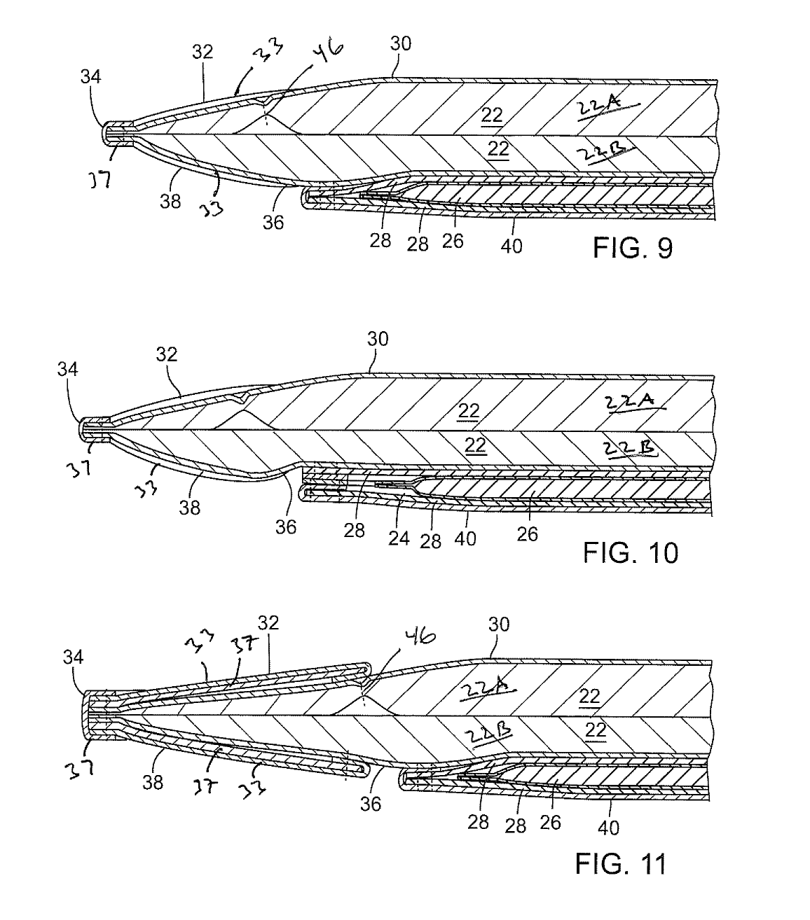

To facilitate heat transfer between the hot/cold pack and the animal, one or more layers of thermally conductive materials 28 may be provided in the pocket as best shown in FIGS. 9, 10 & 11. The thermally conductive material can also serve to insulate the hot/cold pack to preserve how long it will maintain its thermal properties.

Preferably, each pet bed is constructed using a tough 1000 denier Cordura Nylon outer fabric. The inside is made using a 10 once fiberfill batting and each of the rounded corners and pockets of the bed is protected utilizing a 40 ounce truck tarp material creating the ultimate chew and scratch resistant pet bed. The materials are preferably water resistant

More preferably, the gel packs work both Hot & Cold, are non-toxic and microwave and freezer safe.

It can be appreciated that other therapy devices may also be detachably secured within the pocket. For example, Transcutaneous Electrical Nerve Stimulation (commonly known as “TENS”) therapy devices are commonly used to treat people. One such system is disclosed in U.S. Pat. No. 4,917,092 to Todd et al., the disclosure of which is hereby incorporated by reference.

The pockets can be adapted to receive one or more TENS therapy devices therein. Preferably, the TENS therapy device is self-contained and completely sealed within the pocket so as to prevent an animal from becoming entangled or chewing wires extending therefrom.

Other therapy devices that may be detachably received within the pockets include a vibration therapy device such as disclosed in U.S. Pat. No. 8,382,690 to Yoon et al. and U.S. Pat. No. 6,175,981 to Lizama et al., a magnetic therapy device such as disclosed in U.S. Pat. No. 5,817,000 to Souder, an electric heating element such as a conventional heating pad, a conventional liquid cooled and/or heated radiant system that pumps warm and/or chilled liquid through the system, and/or a Pulsed Electromagnetic Field Therapy (“PEMF”) device such as disclosed in U.S. Pat. No. 6,675,047 to Konoplev, all of the disclosures of which are hereby incorporated by reference, and the like. Preferably, the therapy system is self-contained using internal operating components. Moreover, a combination of these devices may also be included as needed.

One skilled in the relevant art will recognize that numerous variations and modifications may be made to the configurations described above without departing from the scope of the present invention, as defined by the appended claims.

What is claimed is:

1. An animal bed having
a first surface for allowing the animal to rest thereon;
an opposite therapy surface for allowing the animal to be treated with a therapy device while resting thereon; and,
a chamber for detachably receiving the therapy device therein.

2. The animal bed of claim 1, wherein padding is operably secured to the first surface to allow the pet to rest on a padded surface.

3. The animal bed of claim 2, wherein the chamber is a pocket operably secured to the therapy surface.

4. The animal bed of claim 3, wherein the pocket includes a securing structure for holding the therapy device therein.

5. The animal bed of claim 4, wherein the securing structure is hook and loop material.

6. The animal bed of claim 1, wherein the therapy device is a temperature therapy device.

7. The animal bed of claim 6, wherein the temperature therapy device is a hot/cold pack.

8. The animal bed of claim 6, wherein the temperature therapy device is a heating pad.

9. The animal bed of claim 8, wherein the heating pad includes an electric heating element.

10. The animal bed of claim 6, wherein the temperature therapy device includes a radiant fluid flow device.

11. The animal bed of claim 1, wherein the therapy device is selected from the list consisting of a magnetic therapy device, a temperature therapy device, a vibration therapy device, a Transcutaneous Electrical Nerve Stimulation (“TENS”) device and a Pulsed Electromagnetic Field Therapy (“PEMF”) device.

12. The animal bed of claim 1 further including a second therapy device operably received within the chamber, the second therapy device selected from the list consisting of a magnetic therapy device, a temperature therapy device, a vibration therapy device, a Transcutaneous Electrical Nerve Stimulation (“TENS”) device and a Pulsed Electromagnetic Field Therapy (“PEMF”) device.

13. The animal bed of claim 3, wherein the padding is formed of a first substantially planar sheet of padding and a second substantially planar sheet of padding. The first substantially planar sheet of padding operably secured to the first surface, and the second substantially planar sheet of padding operably secured to the opposite therapy surface.

14. The animal bed of claim 13, wherein the first substantially planar sheet of padding is operably secured to the first surface with stitching.

15. The animal bed of clam 1, wherein the bed is substantially rectangular defining four corners, and further including substantially planar reinforcing materials operably secured at the four corners.

16. The animal bed of claim 15, wherein the substantially planar reinforcing materials have surface orientation that differs from the surface ornamentation on the first surface.

17. The animal bed of claim 6 wherein the chamber includes a thermally conductive material therein.

18. The animal bed of claim 1, wherein the bed upper surface and therapy surface are constructed of waterproof materials.
